(19) United States
(12) Patent Application Publication
(10) Pub. No.: US 2026/0290284 A1
(43) Pub. Date: Sep. 24, 2026

(54) INFORMATION HANDLING SYSTEM SELECTIVE DISPLAY RESOLUTION ENHANCEMENT

(71) Applicant: Dell Products L.P., Round Rock, TX (US)

(72) Inventors: Deeder M. Aurongzeb, Austin, TX (US); Ghee Beng Ooi, Singapore (SG); Chih Hao Kao, Singapore (SG)

(73) Assignee: Dell Products L.P., Round Rock, TX (US)

(21) Appl. No.: 19/086,329

(22) Filed: Mar. 21, 2025

(51) Int. Cl. G09G 5/373; G06F 3/01; G06T 3/40; G09G 5/10

(52) U.S. Cl. CPC G09G 5/373; G06F 3/013; G06T 3/40; G09G 5/10; G09G 2320/0626

(57) ABSTRACT

An information handling system presents content as visual images at one or more displays with the content sent at a content resolution and converted by a scaler of the display to a display resolution. When the content scales to a higher resolution than source information, artificial intelligence embedded in the scaler enhances the visual information to fill missing pixelization. The scaler limits the enhancement to a gaze area where the end user is viewing the content to reduce power consumption and processing lags. Brightness of the display may also be selectively enhanced in the gaze area to reduce power consumption.

### BACKGROUND OF THE INVENTION

### Field of the Invention

The present invention relates in general to the field of information handling system displays, and more particularly to an information handling system selective display resolution enhancement.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems process information with a processor and memory coupled in a housing. Stationary information handling system configurations, such as desktop and tower systems, interact with end users through peripheral devices, such as a peripheral display, peripheral keyboard and peripheral mouse. Portable information handling system configurations integrate processing components, a display and a power source in a portable housing to support mobile operations. Portable information handling systems allow end users to carry a system between meetings, during travel, and between home and office locations so that an end user has access to processing capabilities while mobile. Portable information handling systems also will typically support end user interactions through peripheral devices. As an example, an end user can interface a portable information handling system with two separate peripheral displays and interact through both the integrated and a peripheral keyboard. This arrangement will support an end user participating in a videoconference with an integrated or peripheral camera while viewing video conference participants at one peripheral display, a presentation at a second peripheral display and email at the portable information handling system display.

Information handling system displays present visual images under the management of a scaler integrated circuit that controls how visual images are scaled and then scanned as pixel values to a display panel. For instance, visual images may be generated as an array of pixels in high definition of 1920x1080 resolution, in 4K resolution and in 8K resolution. When the visual images provided from an information handling system graphics processor have a lower resolution, the contents are scaled up to make the resolution of the display panel with a resulting degradation in the quality of the presentation of the content. One recent improvement for managing display presentation of low resolution visual images is to use artificial intelligence to enhance the visual image where detail is degraded because of scaling from a low resolution to a higher resolution. Filling in the additional details improves the end user experience although the additional processing may take additional time and consume additional power. The scaler also manages illumination of the display panel with a backlight, such as light emitting diodes (LEDs) distributed behind the display panel pixel array. When the display presents visual images with High Dynamic Range (HDR) contents, the backlight tends to illuminate with increased brightness, which increases power consumption.

### SUMMARY OF THE INVENTION

Therefore, a need has arisen for a system and method which presents visual images at a display panel with improved resolution and/or brightness and with reduced power consumption.

In accordance with the present invention, a system and method are provided which substantially reduce the disadvantages and problems associated with previous methods and systems for presenting visual images at a display. An end users interactions with a display are applied to selectively enhance visual images with artificial intelligence (AI) processing by a neural processing unit (NPU) or similar AI processing resource embedded in a display scaler.

More specifically, an information handling system processes information with a processor that executes instructions in cooperation with a memory that stores the instructions and information. One or more displays interfaced with the information handling system presents the information as visual images scaled to a display panel by a scaler included in the display. The scaler includes an embedded AI processing resource, such as an NPU included in the scaler integrated circuit or chipset, that enhances visual images resulting from scaling of content. The scaler assigns AI resources to enhance the visual images based upon indications of an end user’s interactions with the visual images. For instance, a gaze area is determined from a camera detection of an end user gaze at the display so that enhance visual image AI processing is concentrated in the gaze area while not performed or performed to a less degree outside of the gaze area. In addition, the scaler manages display backlight illumination to dim the backlight outside of the area of interest to the end user while enhancing brightness within the gaze area. When an end user has multiple displays interfaced with an information handling system, the enhanced visual image processing is performed at the active display as indicated by the gaze detection or input device interactions while the nonactive display disables or reduces AI processing and dims the display panel backlight. As an end user shifts eye gaze to different areas of the display panel, the AI processing by the scaler adjusts to keep the area of interest to the end user at an enhanced appearance.

The present invention provides a number of important technical advantages. One example of an important technical advantage is that a display panel selectively presents visual images enhanced by an AI processing resource to provide an improved end user experience while limiting enhanced visual image processing outside of an area of interest to the end user to reduce power consumption and visual image presentation lag. Further enhancements of the end user experience and power savings are provided by selectively brightening and dimming the visual images based upon end user interactions. Eye tracking to determine a gaze area of the display narrows the gaze area to an area of interest to an end user and an area in which the enhanced visual image processing will be perceived by the end user.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system having a display configured to enhance visual images at scaling based on a detected user gaze area;

FIG. 2 depicts an example of display having visual images enhanced in a detected end user gaze area;

FIG. 3 depicts a block diagram of a scaler configured to enhance visual images based at least in part on an end user gaze area;

FIG. 4 depicts a flow diagram of a process for managing display scaler image enhancement based upon an end user display gaze area; and

FIG. 5 depicts a flow diagram of a process for managing display scaler image enhancement based upon end user interactions with display content.

### DETAILED DESCRIPTION

Enhancement of visual images presented by an information handling system at a display is limited to an end user gaze area at the display. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

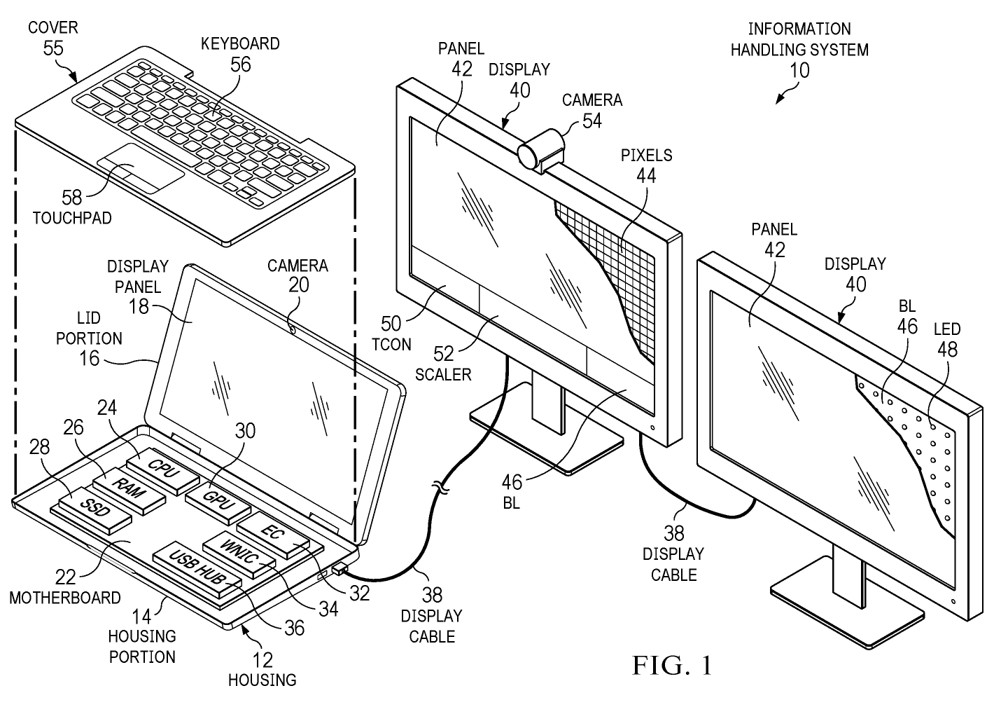

Referring now to FIG. 1, a block diagram depicts an information handling system 10 having a display 40 configured to enhance visual images at scaling based on a detected user gaze area. Information handling system 10 is built in a portable housing 12 having a main housing portion 14 rotationally coupled with a lid portion 16. In alternative embodiments, other types of housing configurations may be used, such as desktop and tower systems that operate in a stationary location. Portable housing 12 integrates a display panel 18 into the housing lid portion 16 to present visual images and a camera 20 to capture visual images of a viewing area of the display. A motherboard 22 couples in housing main portion 14 to interface processing components that cooperate to process information. A central processing unit (CPU) 24 executes instructions to process information in cooperation with a random access memory (RAM) 26 that stores the instructions and information. A solid state drive (SSD) 28 provides non-transient storage of instructions and information during system power down, such as an operating system and applications that are retrieved to RAM 26 at system power up. A graphics processing unit (GPU) 30 further processes information to present at a display panel, such as by defining pixel values that set colors for pixels to generate visual images. An embedded controller 32 executes firmware to manage component interactions, such as application of power and management of thermal constraints. Embedded controller 32 also manages interactions with external devices, such as keyboards and mice. A wireless network interface controller (WNIC) 34 supports wireless communication, such as through WIFI and BLUETOOTH. A USB hub 36 supports communication through USB cables, such as a display cable 38 that communicates visual images to a display 40. The processing components are contained by housing cover portion 55 that couples over the housing main portion and supports an integrated keyboard 56 and touchpad 58.

In the example embodiment, GPU 30 generates visual images for presentation at three display panels simultaneously. Display panel 18 is integrated in portable housing 12. Displays 40 interface through display cables 38 as peripheral display devices and present visual images at display panels 42. Each display panel has an array of pixels 44 that receive pixel values from a timing controller 50 to set a color, such as by applying an electric field to a liquid crystal material that filters light passing through the display panel from a backlight 46. In the example embodiment, backlight 46 is provided with a dispersed arrangement of light emitting diodes (LEDs) 48 that illuminate with a brightness varied under the management of a scaler 52. Scaler 52 is an integrated circuit and/or chipset that receives visual information from GPU 30 and scales the visual images for presentation at the resolution of the array of pixels 44.

One feature of scaler 52 is that an embedded artificial intelligence (AI) agent, such as a neural processing unit (NPU) running an AI model, enhances scaling of visual images when a content at a lower resolution, such as HD 1920X1080, is scaled to a higher resolution, such as 4K or 8K. Essentially, the AI agent estimates missing pixel values in the high resolution that are filled in between the known pixel values of the lower resolution. Camera 54 determines a gaze direction of an end user towards the display, such as with infrared reflections from the end user pupils, to assign a gaze area of the display panel that is AI enhanced while the area outside of the gaze area is not enhanced. By reducing the amount of display area that has to be processed for enhancement, the power consumption and compute time of the scaler is reduced. In addition, LEDs 48 in the gaze area have a greater brightness setting than LEDs outside of the gaze area where the dimmed and less enhanced visual images are not within the focused viewing area of the end user. When the gaze area is in one display 40, the other display may have AI enhancement turned off or performed at a lower state and may also dim the backlight. The gaze area from camera 54 may be communicated through display cables 38 between displays 40 when the displays are daisy-chained. Alternatively, the gaze area may be communicated to GPU 30 or embedded controller 32 and then communicated out to the displays 40. In one embodiment, AI enhancement and local dimming may also be performed at the display panel 18 integrated in the portable housing in cooperation with the peripheral displays 40.

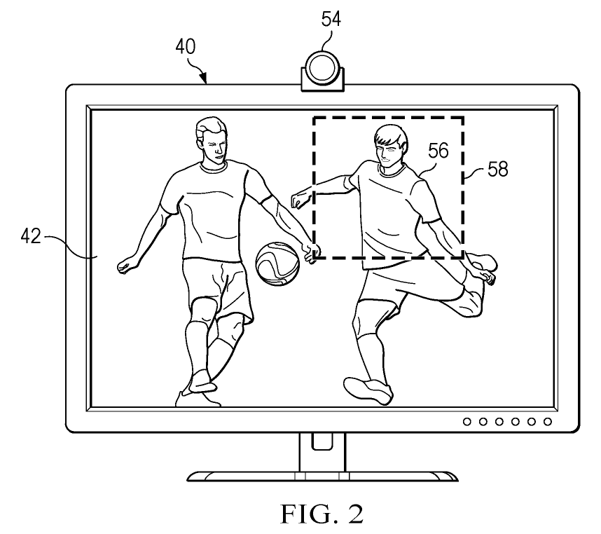

Referring now to FIG. 2, an example is depicted of a display 40 having visual images enhanced in a detected end user gaze area 58. Camera 54 detects the end user gaze and estimates based upon the gaze direction and distance a gaze area 58 at display panel 42 in which the end user perception of visual images will benefit from AI enhancement. The visual image 56 is enhanced by AI processing within gaze area 58 and not enhanced (or enhanced to a lower degree) outside of gaze area 58. In addition, display brightness may be increased within the gaze area and dimmed without the gaze area so that the visual images within the gaze area capture the end user’s attention. Enhancing visual images and brightness in the gaze area and not outside of the gaze area reduces power consumption and processing lag.

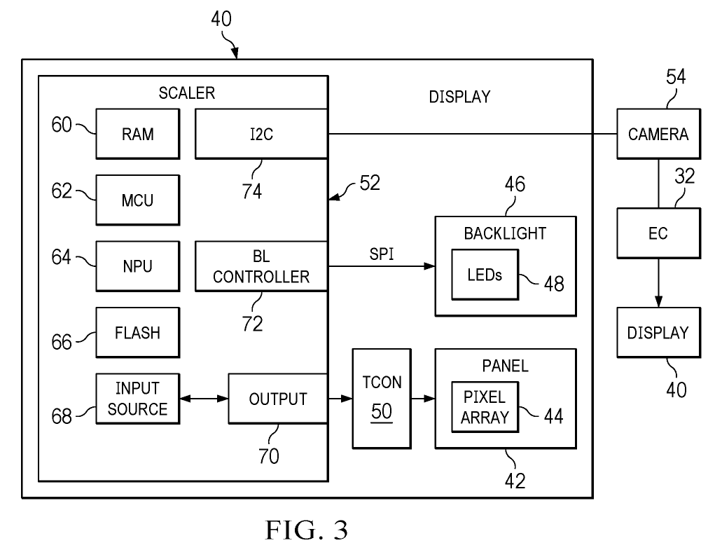

Referring now to FIG. 3, a block diagram depicts a scaler 52 configured to enhance visual images based at least in part on an end user gaze area. Scaler 52 accepts visual images from an input source 68, such as HDMI or other video source protocols, and outputs the visual images as a video output 70, such as a 16 lane eDP output to a timing controller 50 that scans the visual images as pixel values to a pixel array 44 of a display panel 42. Scaler 52 includes RAM 60 that stores visual image information, such as with a frame buffer, so that an MCU or similar processing resource can scale the visual image to a desired resolution, such as by executing instructions stored in flash memory 66 or other non-transient memory. During the scaling, the visual image appearance is enhanced by an AI agent executing on NPU 64, which can be included in a chipset of the scaler or as an embedded integrated circuit unit. NPU 64 enhances the visual image by filling in visual image pixel values where the visual image information is imprecise, such as when scaling is to a higher resolution display than the resolution of the underlying visual image information. Camera 54 captures a visual image of an end user to detect a gaze area where the end user is viewing display 40 and communicates the gaze area through a peripheral serial bus to scaler 52, such as I2C bus 74. To save power and reduce processing lag, NPU 64 enhances visual images in only the gaze area, leaving the display panel pixels outside of the gaze area unenhanced. Alternatively, the amount of processing by NPU 64 to enhance the visual images is decreased outside of the gaze area. MCU 62 also applies the gaze area to determine areas of the display at which backlight controller 72 commands through a SPI link to have backlight 46 dim LEDs 48. In the example embodiment, a second display 40 receives the gaze area from camera 54 through embedded controller 32 and, when the gaze area is on the first display 40, disables AI agent enhancement and dims the brightness of the display panel. As the gaze area changes location across the displays, some hysteresis may be applied to smooth changes in visual image processing. When no gaze area is detected at any display, the AI agent processing may be switched off at both displays.

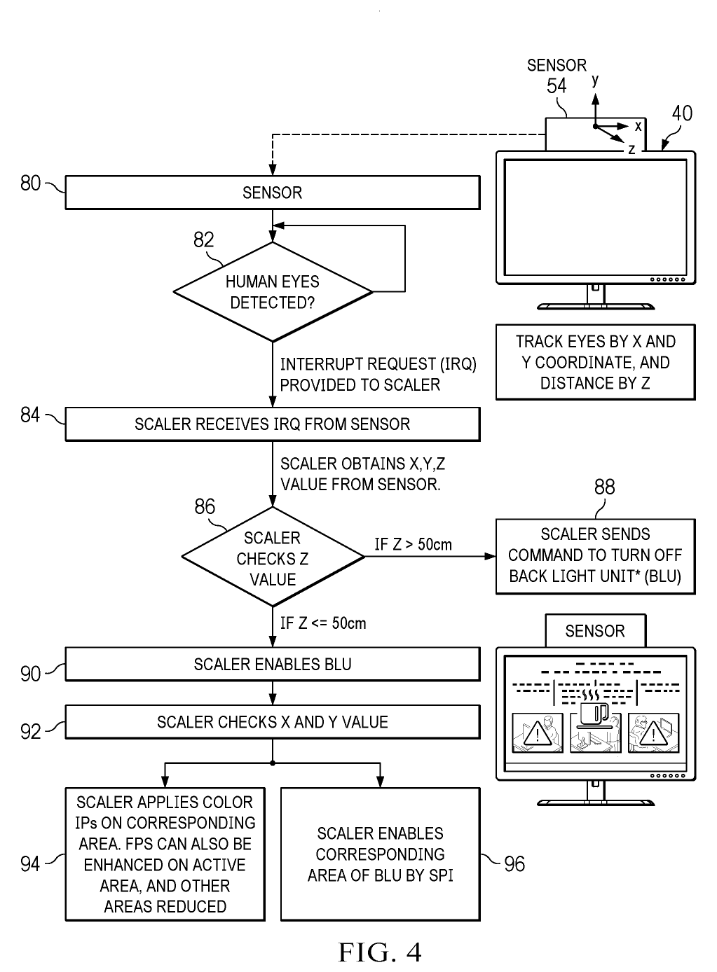

Referring now to FIG. 4, a flow diagram depicts a process for managing display scaler image enhancement based upon an end user display gaze area. The process starts at step 80 with detection of an end user gaze by a camera or similar sensor in a reference coordinate system relative to the camera expressed in X, Y and Z directions. At step 82 a determination is made of whether a gaze is detected. When no gaze is detected, the AI agent may be turned off and the brightness may be powered down. When a gaze is detected an interrupt is communicated to the scaler from the camera and received at the scaler at step 84. The scaler retrieves the X, Y and Z values from the sensor and at step 86 the scaler checks the Z value to detect the distance to the display. If at step 86 the Z distance is greater than a nominal value, such as 50cm, the process continues to step 88 to have the scaler turn off the backlight to save power. Turning off the backlight while leaving the display panel active provides for a rapid wake when an end user is detected at less than the nominal value. When the backlight is powered off, the AI agent may also be powered off. When at step 86 the Z distance is less than the nominal value, the process continues to step 90 to enable the backlight and to step 92 to check the X and Y values. Applying the X and Y values, the process continues to steps 94 and 96. At step 94 the scaler applies the coordinates to determine the gaze area and enhance color and frame per second processing in the gaze area, such as with an AI agent executing on an NPU. Outside of the gaze area, the AI agent processing may be reduced to have unenhanced visual images, although the unenhanced visual images may have some low level of AI agent processing applied. At step 96 the scaler enables the backlight in the gaze area to enhance brightness while visual images outside of the gaze area may be presented at a dimmed brightness.

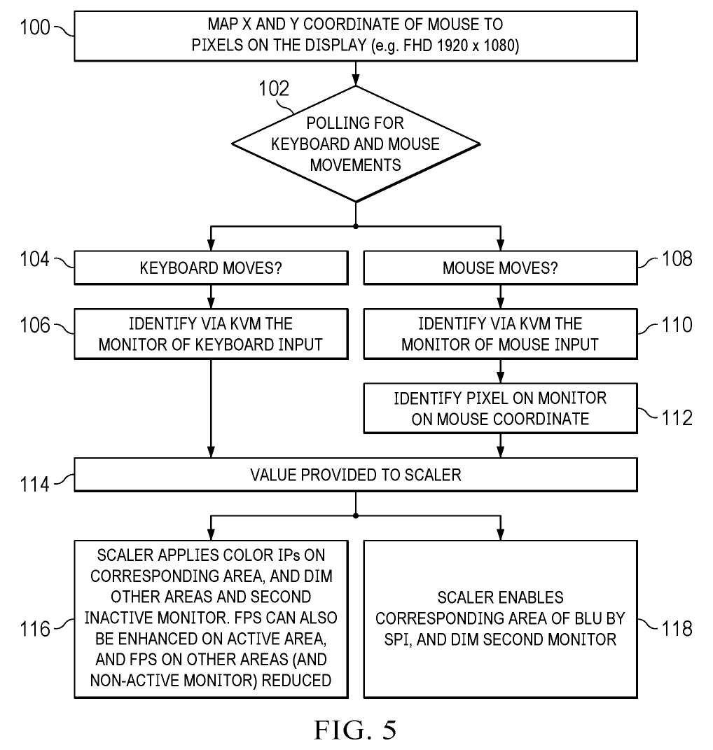

Referring now to FIG. 5, a flow diagram depicts a process for managing display scaler image enhancement based upon end user interactions with display content. The process starts at step 100 with the mapping of coordinates of a mouse cursor to pixels on the display. This mapping allows the scaler to know exactly the location of an end user gaze by assuming that the end user is interacting with display content at the mouse cursor. In one embodiment, the active area of interest may be assumed to be in a window of the display that has content, such as a window showing a movie or a window performing CAD or word processing. In such a situation, the gaze area may be assigned as that window so that the content in the window has enhanced visual processing by the NPU while the content outside of the window does not have enhanced visual processing. At step 102, the scaler polls for keyboard and mouse movements that indicate end user interactions. When a keyboard movement is detected the process continues to step 104 and at step 106 the display panel having the keyboard movement is determined from a keyboard video mouse (KVM) switch interfaced with the displays. Alternatively, each scaler may interact with the system GPU or embedded controller to poll for keyboard movement. If at step 102 a mouse movement is detected, the process continues to step 108. At step 110, the display panel associated with the mouse input is detected through the KVM switch and at step 112 the pixel of the display panel on which the mouse cursor is located is identified.

Once the end user interactions by mouse or keyboard are determined, the process continues to step 114 where the coordinate values of the end user interaction by mouse or keyboard are provided to the scaler. At step 116 the scaler performs visual image enhancement at the active area of the display panel while not enhancing portions of the display that are not active. In one example embodiment, the display panel having end user interactions has enhanced visual image processing with the NPU while the other display panel does not. In other embodiments, the portion of the display that has active interactions is further identified so that only that portion receives enhanced visual image processing. The specific area may be identified by an active window of content or by end user interactions with content. In one embodiment, the NPU can itself predict which portions of the display should receive enhanced visual image processing and then apply the enhancement at the predicted area. Along with the enhanced visual image processing, the display panel may have brightness enhanced in areas of end user interactions while dimmed outside of those areas. In one alternative embodiment, the NPU may perform analysis to determine how the brightness of the display can be most effectively enhanced and dimmed. At step 118, the scaler applies the end user interaction to dim the backlight outside of the interaction and at any display panels that are not active. Dimming the backlight outside of the end user interaction saves power and enhances the end user experience by having the area of interest to the end user shown with relatively greater brightness.

Although the present invention has been described in detail, it should be understood that various changes, substitutions and alterations can be made hereto without departing from the spirit and scope of the invention as defined by the appended claims.

What is claimed is:

1. An information handling system comprising:
a housing;
a processor coupled in the housing and operable to execute instructions that process information;
a memory coupled in the housing and interfaced with the processor, the memory operable to store the instructions and information;
a camera interfaced with the processor and operable to capture camera visual images;
a display interfaced with the processor and operable to present the information as content visual images, the display having a display panel with an array of pixels that define the visual images, a timing controller interfaced with the display panel that scans pixel values to the array of pixels, a scaler interfaced with the timing controller that scales the visual image from a content resolution to a display panel resolution and a processing resource interfaced with the scaler to enhance the content visual images at the display panel resolution by estimating pixel values not defined by the content resolution when converted to the display panel resolution; and
a non-transitory memory interfaced with the scaler storing instructions that when executed on the scaler cause:
detection from the camera visual images of a gaze area of the display panel based upon an end user gaze towards the display panel; and
enhancing the content visual images only in the gaze area.

2. The information handling system of claim 1 further comprising:
the processing resource embedded in the scaler;
the non-transitory memory embedded in the scaler; and
the camera directly interfaced with the scaler through a serial peripheral communication link.

3. The information handling system of claim 2 further comprising:
a backlight behind the display panel and configured to illuminate the array of pixels; and
an instruction stored in the non-transitory memory that when executed on the scaler causes the backlight to illuminate the gaze area brighter than the display panel outside of the gaze area.

4. The information handling system of claim 3 wherein the processing resource comprises an NPU embedded in the scaler.

5. The information handling system of claim 1 further comprising:
first and second of the displays interfaced with the processor; and
instructions stored in the non-transitory memory of each of the first and second displays that when executed on the scaler cause:
detection of the gaze area at only one of the first and second displays; and
enhancing the content visual images in only the one of the first and second display.

6. The information handling system of claim 5 further comprising an instruction in the non-transitory memory that when executed on the scaler causes brighter illumination at only the one of the first and second displays compared to the other of the first and second displays.

7. The information handling system of claim 5 wherein both the first and second displays are peripheral displays separate from the housing.

8. The information handling system of claim 5 wherein:
the housing comprises a portable housing;
the first display integrates in the portable housing; and
the second display is a peripheral display separate from the housing.

9. The system of claim 8 wherein the camera integrates in the portable housing.

10. A method for presenting visual images at a display, the method comprising:
scaling visual images from a content resolution to a display panel resolution;
enhancing the visual images at the display panel resolution by estimating pixel values not defined by the content resolution when converted to the display panel resolution;
detecting an end user gaze at the display panel in a gaze area; and
enhancing the visual images in only the gaze area.

11. The method of claim 10 further comprising:
enhancing the visual images with artificial intelligence at an NPU embedded in a scaler of the display.

12. The method of claim 10 further comprising:
illuminating the gaze area brighter than the display panel outside of the gaze area.

13. The method of claim 10 further comprising:
interfacing a second display with the display;
detecting of the gaze area at only one of the display and the second display; and
enhancing the content visual images in only the one of the display and the second display.

14. The method of claim 13 further comprising generating brighter illumination at only the one of the display and the second display compared to the other of the display and the second display.

15. The method of claim 13 wherein the second display comprises a display panel integrated in a portable information handling system housing.

16. A display comprising:
a display panel with an array of pixels that present visual images;
a timing controller interfaced with the display panel that scans pixel values to the array of pixels;
a scaler interfaced with the timing controller that scales the visual image from a content resolution to a display panel resolution;
a processing resource interfaced with the scaler to enhance the content visual images at the display panel resolution by estimating pixel values not defined by the content resolution when converted to the display panel resolution; and
a non-transitory memory interfaced with the scaler storing instructions that when executed on the scaler cause:
detection from camera visual images captured by a camera of a gaze area of the display panel based upon an end user gaze towards the display panel; and
enhancing the content visual images only in the gaze area.

17. The display of claim 16 further comprising:
a backlight behind the display panel and configured to illuminate the array of pixels; and
an instruction stored in the non-transitory memory that when executed on the scaler causes the backlight to illuminate the gaze area brighter than the display panel outside of the gaze area.

18. The display of claim 17 further comprising:
the processing resource embedded in the scaler as an NPU;
the non-transitory memory embedded in the scaler; and
a camera directly interfaced with the scaler through a serial peripheral communication link.

19. The display of claim 16 further comprising:
first and second of the display panels, the first of the display panel interfaced with a first of the scalers, the second of the display panels interfaced with a second of the scalers; and
instructions stored in the non-transitory memory that when executed on one of the first scaler or second scaler cause:
detection of the gaze area at only one of the first and second display panels; and
enhancing the content visual images in only the one of the first and second display panels.

20. The display of claim 19 further comprising an instruction in the non-transitory memory that when executed on the one of the first and second scalers causes brighter illumination at only the one of the first and second displays compared to the other of the first and second displays.
